(19) United States
(12) Patent Application Publication
(10) Pub. No.: US 2026/0365131 A1
(43) Pub. Date: Nov. 19, 2026

(54) RESTRAINT SYSTEM OF A MOTOR VEHICLE FOR RESTRAINING AN OCCUPANT SITTING ON A VEHICLE SEAT, AND INFLATABLE AIRBAG

(71) Applicant: Autoliv Development AB, Vargarda (SE)

(72) Inventors: Fredrik FYHR, Vargarda (SE); Lars CARLSTEDT, Vargarda (SE); Goran KARLSSON, Vargarda (SE); Per AXBLOM, Alingsås (SE)

(21) Appl. No.: 19/477,358

(22) PCT Filed: Apr. 19, 2024
(86) PCT No.: PCT/EP2024/060691

§ 371 Date: Oct. 21, 2025

(30) Foreign Application Priority Data
Apr. 21, 2023 (DE) 10 2023 110 185.4

(51) Int. Cl. B60R 21/18; B60R 21/00; B60R 21/231; B60R 21/264

(52) U.S. Cl. CPC B60R 21/18; B60R 21/231; B60R 21/264; B60R 2021/0032

(57) ABSTRACT

A restraint system of a motor vehicle for restraining an occupant sitting on a vehicle seat, having a seat belt device with an inflatable airbag, and a gas generator which is connected in terms of flow to the airbag and, upon activation, inflates the airbag with a gas, wherein the airbag has a holder for holding the airbag on a diagonal belt portion of a seat belt of the seat belt device which diagonal belt portion crosses the chest of the occupant, wherein the airbag has a triangular basic shape with rounded corners, and the airbag in the inflated state has an orientation defined by its mounting on the diagonal belt portion, with two rounded corners arranged horizontally next to each other and with a rounded corner extending centrally upwards between the horizontally arranged corners.

The present invention relates to a restraint system having the features of the preamble of claim 1 and to an inflatable airbag according to the preamble of claim 10.

Seat belt devices for motor vehicles have long been known in the prior art and serve to restrain the occupants in the event of an accident in order to prevent serious injury. For this purpose, seat belt devices having a seat belt designed as a 3-point belt have proven particularly successful, in which devices the seat belt is fastened by one end to the vehicle structure via an end fitting on a lower side of a vehicle seat, and can be taken up with the other end on a belt retractor fastened to the same side. A belt tongue is guided so as to be displaceable on the seat belt, which belt tongue can be locked on a belt buckle arranged on the other side of the vehicle seat, in order to realize the 3-point geometry of the seat belt. In the locked position, the belt tongue then divides the seat belt into a diagonal belt portion crossing the chest of the occupant, and a lap belt portion crossing the pelvis of the occupant.

Furthermore, airbag systems have long been known in the prior art, which can be arranged at different locations in the vehicle and have an airbag which, in the event of an accident, is inflated suddenly to a significantly increased volume via a gas generator. For example, front airbags, side airbags, curtain airbags, knee airbags, and overhead airbags are known, which restrain the occupants in special accident scenarios due to their arrangement and deliberately designed inflation behavior and their inflation geometry, and in particular prevent an impact of the occupant against the interior vehicle structure in the event of an accident. A particularly important airbag is the front airbag, which is arranged in the steering wheel for the driver, and in the instrument panel for the front-seat passenger. When front airbags are also provided for occupants on the back seats, these are arranged in the backrests or the head rests of the front seats. The front airbag basically serves to catch an occupant, sitting facing the direction of travel, in the event of a frontal impact, and to protect him from striking his head or the upper body on the interior vehicle structure or on the inside of the windshield. If such an impact cannot be prevented in the event of a very serious accident, at least the impact momentum can be reduced thereby.

In modern vehicles, restraint systems having a combination of restraint of the occupants by a seat belt and an airbag have proven to be particularly useful, wherein the restraint of the occupant is achieved in an initial phase via the seat belt and in a later phase of the forward displacement via the airbag. In this case, the load on the occupant can be further reduced by a targeted use of irreversible or reversible belt tensioners and force-limiting devices, and the forward displacement can thereby be controlled.

However, despite the considerable reduction in the load on the occupant, a disadvantage of such restraint systems can be seen in that the restraint requires a certain orientation of the occupants in relation to the airbag systems, in particular in the case of restraint by the airbag systems. In this case, what are known as “out of position” (OOP) situations are particularly problematic, if the occupant is, for example, bending down into the footwell, is in an extreme sleeping position, or is turned towards the back seats. The effect of the airbag system is considerably reduced as a result. Although the airbag is then inflated, the occupant executes a completely different movement due to being OOP, and is then not caught by the airbag system. Furthermore, although the seat belt devices and the airbags are fastened to the vehicle independently of each other, which in itself already increases the assembly effort, they must nevertheless be matched to each other in their restraint characteristics, even in their separate arrangement, which results in a considerable complexity in the design.

A restraint system having a combination of a seat belt device and an airbag arranged on the seat belt of the seat belt device is already known from US 2014/0159350 A1, in which the occupant is restrained both by the seat belt and by the airbag which deploys on the seat belt. In this case, the airbag comprises an inflatable airbag having a chamber which is held on the pelvis belt portion or diagonal belt portion and which when activated deploys in front of the upper body of the occupant.

Document DE 10 2021 111 522 A1 discloses a restraint system having a seat belt with a diagonal belt portion, in which an airbag with a main chamber and an additional chamber is provided on the diagonal belt portion, wherein the main chamber has a specific geometry with a wider central portion and two narrower edge portions, and the additional chamber is connected to the main chamber at the central portion. The additional chamber can provide additional damping of the further forward displacement of the occupant after first contact. Furthermore, the occupant is restrained over a greater width due to the wider central portion of the main chamber.

Against this background, the invention is based upon the object of providing a restraint system having a seat belt device with a seat belt and an airbag held on a diagonal belt portion of the seat belt and an inflatable airbag for mounting on a diagonal belt portion, which are to have a simplified structural design and at the same time are to provide for good restraint of the occupant in the event of an accident.

The basic idea of the invention is to provide for a restraint system according to the preamble of claim 1 in which the airbag has a triangular basic shape with rounded corners, and the airbag in the inflated state has an orientation defined by its mounting on the diagonal belt portion, with two rounded corners arranged horizontally next to each other and with a rounded corner extending centrally upwards between the horizontally arranged corners.

The advantage of the proposed restraint system is that the airbag is formed from a single inflatable chamber and thus has a much simpler structural design. This makes the restraint system considerably more cost-effective to manufacture. The restraint system moreover has improved restraint characteristics due to the proposed shape and orientation of the airbag, in that the occupant is restrained in a widened portion in the upper body area and in particular in the shoulder area via the portion of the rounded corners arranged horizontally to each other, while being restrained in the head area via the region of the rounded corner of the airbag extending centrally upwards. The restraint system is thus better adapted to the body structure of the occupant by the shape and the orientation of the airbag defined by the mounting. The shape and orientation of the airbag are specifically designed such that the occupant's head and shoulders plunge into the airbag when restrained. The head and shoulders are particularly important to protect because injuries to said parts of the body are particularly serious. Moreover, said parts of the body move the greatest distance forward in an accident and are subject to the greatest acceleration, so that the load on said parts of the body is particularly great in case of an impact. This means that the likelihood of serious injuries to the occupant in case of an accident can be particularly effectively reduced by said parts of the body having special protection due to the specifically shaped airbag, which is suitably oriented due to its fastening to the diagonal belt portion. The mounting on the diagonal belt portion is of particular importance because, due to the geometry of the seat belt, the diagonal belt portion is always positioned in front of the occupant's chest when the seat belt is fastened, and the airbag, due to its mounting thereon, is thus also positioned in front of the occupant's chest when the seat belt is fastened.

It is further proposed that the corners of the airbag arranged horizontally next to each other be arranged on different sides of the diagonal belt portion in the inflated state of the airbag. In addition to the restraint provided by the diagonal belt portion, the occupant is thus also restrained by the inflated airbag on both sides of the diagonal belt portion.

It is further proposed that the centrally upwards-extending rounded corner of the airbag, when inflated, be arranged above the diagonal belt portion. This means that, above the diagonal belt portion, the occupant is restrained more effectively across his central body region and in particular across his neck extending from the shoulders and his head extending from the neck.

It is further proposed that the rounded corners arranged horizontally next to each other have a smaller radius than the centrally raised rounded corner. Due to the larger radius of the centrally raised rounded corner, the restraint can be better adapted to the comparatively large head in comparison to the smaller shoulders, by making the airbag larger or wider in the region of the centrally raised rounded corner due to the larger radius in the middle.

It is further proposed that the airbag have a radially inwardly curved shape on its edge faces that connect the rounded corners to each other. The proposed development allows the volume of the airbag to be reduced without this having a negative impact on its restraint function. Conversely, the utilization rate of the gas volume generated by the gas generator for restraining the occupant can be increased. This allows the volume of gas to be generated to be reduced, and thus the size of the gas generator itself to be reduced. Also, the airbag inflation time until fully deployed can be reduced while maintaining the same gas volume generation rate.

It is further proposed that the airbag have a smaller radius of curvature on the lower edge face, which connects the two rounded corners arranged horizontally next to each other, than on the lateral edge faces, which connect the rounded corners arranged horizontally next to each other to the upper, central rounded corner. Due to the proposed solution, the edge face, which connects the two rounded corners arranged horizontally next to each other, extends deeper into the airbag than the two edge faces, which extend to the upper, central rounded corner. This is advantageous because the occupant is restrained at a larger contact surface in the area of the head and the transition to the shoulders, which is important when restraining the occupant, while the gas volume of the airbag is deliberately reduced by a greater reduction in the contact surface in the central chest region of the occupant, which is restrained in any case by the diagonal belt portion.

It is further proposed that the airbag be symmetrical with respect to a vertically oriented axis of symmetry which extends centrally through the upwards-extending rounded corner of the airbag. This ensures that the occupant is restrained symmetrically.

It is further proposed that the diagonal belt portion have a gas line which connects the gas generator, in terms of flow, to the airbag. The airbag is thus filled by an external gas generator through the gas line of the diagonal belt portion, so that no gas generator needs to be arranged directly on the airbag. The airbag can therefore be fastened to the diagonal belt portion without a gas generator and with a significantly reduced installation space requirement.

It is further proposed that a tensioning strap be provided, which connects the airbag to the diagonal belt portion and limits a deflection of the airbag in the inflated state. The tensioning strap holds the airbag in a specific orientation to the diagonal belt portion and to the occupant strapped therewith during inflation and in particular when fully inflated, so that it can be used optimally to restrain the occupant. Furthermore, the airbag is held in a predetermined position relative to the occupant and the diagonal belt portion via the tensioning strap even during forward displacement of the occupant and while the occupant is restrained.

Furthermore, to achieve the object, an inflatable airbag for mounting on a diagonal belt portion of a seat belt device is proposed, wherein the airbag has a triangular basic shape with rounded corners, and the airbag in the inflated state has an orientation, defined by its mounting on the diagonal belt portion, with two rounded corners arranged horizontally next to each other and with a rounded corner extending centrally upwards between the horizontally arranged corners. The proposed inflatable airbag can be provided as additional equipment on an otherwise unchanged seat belt device, wherein the inflatable airbag needs to be provided only with a holder for fastening to the diagonal belt portion.

The airbag with its holder is preferably designed such that the rounded corners of the airbag in the inflated state, which corners are arranged horizontally next to each other, are arranged on different sides of the diagonal belt portion. The airbag thus provides symmetrical support for the occupant on both sides of the diagonal belt portion and is held in position by the holder on the diagonal belt portion during inflation and during restraint.

Furthermore, the holder of the airbag is designed such that the centrally upwards-extending rounded corner of the airbag is arranged above the diagonal belt portion in the inflated state of the airbag. The airbag, with its central corner arranged above the diagonal belt portion, provides improved restraint for the occupant above the diagonal belt portion, in particular in the area of the upper body and head.

It is further proposed that the rounded corners arranged horizontally next to each other have a smaller radius than the centrally raised rounded corner. The shape of the airbag is therefore specifically designed to restrain the occupant in the area of his head and shoulders, which travel the greatest distance when the occupant is moved forward in an accident.

The gas volume required to inflate the airbag can be reduced, without negatively affecting the restraint function of the airbag, by giving the airbag a radially inwardly curved shape on its edge faces that connect the rounded corners to each other.

The gas volume can be further reduced, without impairing the restraint function, in particular by the airbag having a smaller radius of curvature on the lower edge face, which connects the two rounded corners arranged horizontally next to each other, than on the lateral edge faces, which connect the rounded corners arranged horizontally next to each other to the upper, central rounded corner.

It is further proposed that the airbag be symmetrical with respect to an axis of symmetry which extends centrally through the upwards-extending rounded corner. The airbag thus enables symmetrical restraint of the occupant with the lowest and most even load on the occupant possible in case of an accident.

The invention is explained below using preferred embodiments with reference to the accompanying figures. In the figures:

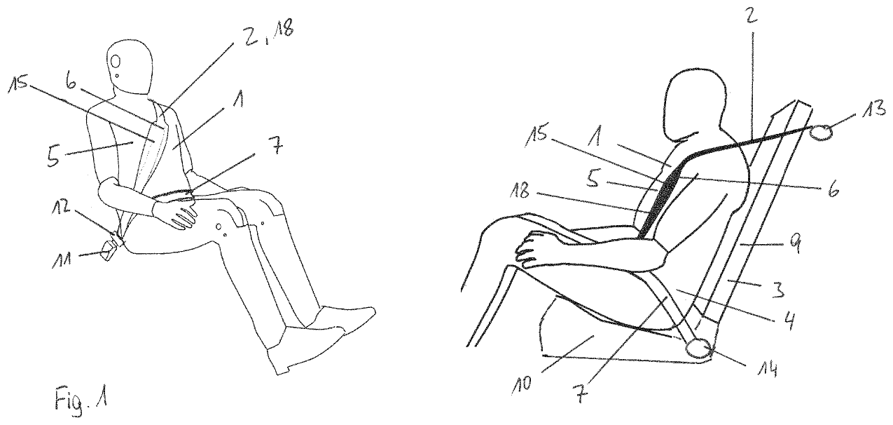

FIG. 1 shows a first and second perspectival view of an occupant with a restraint system according to the invention having an airbag according to the invention, in a normal buckled position; and

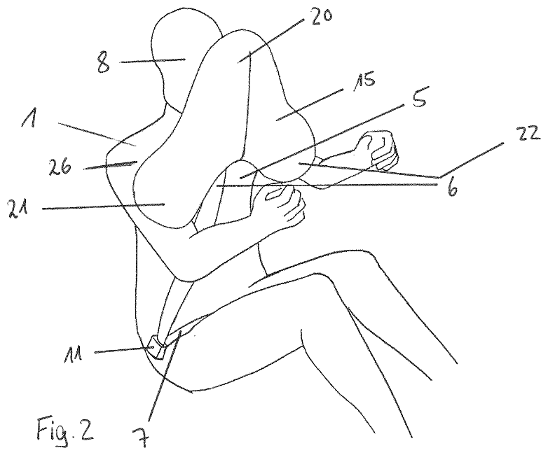

FIG. 2 shows the restraint system according to the invention of FIG. 1 with the inflated airbag; and

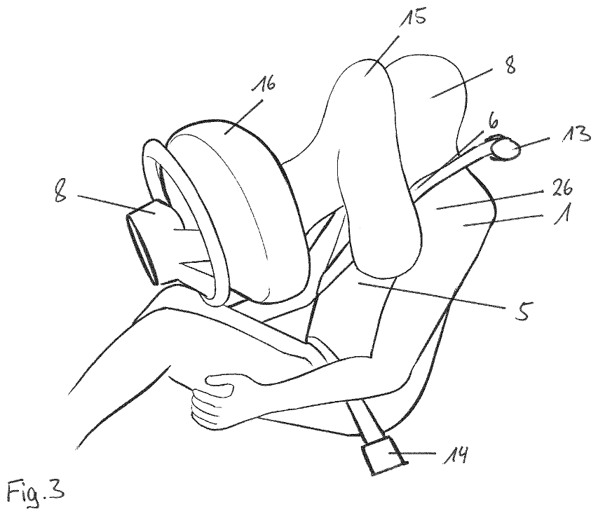

FIG. 3 shows the restraint system according to the invention of FIG. 1 with the inflated airbag and a steering wheel with an inflated driver airbag; and

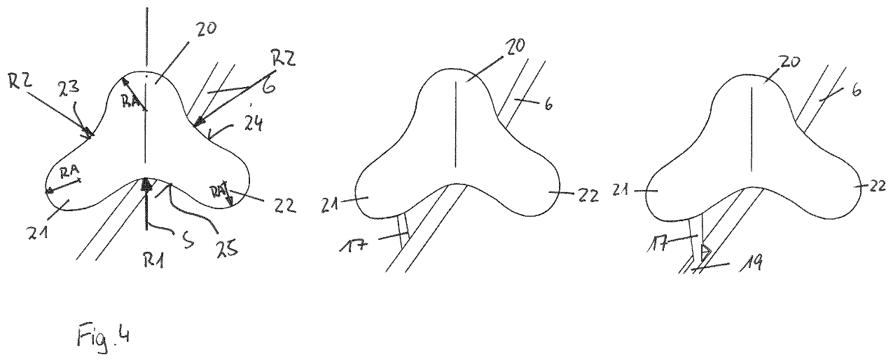

FIG. 4 shows a cutout of a diagonal belt portion with an inflated airbag in three different embodiments.

FIG. 1 shows an occupant 1 sitting on a vehicle seat 3 having a backrest 9 and a seat surface 10, which occupant is restrained by an applied seat belt 18 of a seat belt device 2. At its first upper end, the seat belt 18 is rolled onto a first belt retractor 13, and, at its second lower end, it is fastened, via an end fitting 14, to the vehicle structure or to the vehicle seat 3 or can be rolled onto a second belt retractor that is fixedly installed in the vehicle. The first belt retractor 13 can also either be fastened to the vehicle seat 3, as here, for example, in the region of an upper edge of the backrest 9, or to the vehicle structure, wherein additional deflections of the seat belt 18 can be provided in the routing of the first belt retractor 13. A belt tongue 12, which can be seen in the left-hand illustration of FIG. 1, is displaceably guided on the seat belt 18, which belt tongue can be locked in a belt buckle 11 arranged on the other side of the vehicle seat 3, in relation to the end fitting 14 and the first belt retractor 13. In a position locked in the belt buckle 11, the belt tongue 12 divides the seat belt 18 into a diagonal belt portion 6 crossing the chest 5 of the occupant 1 and a lap belt portion 7 crossing the pelvis 4 of the occupant 1. In addition, further irreversible or reversible belt tensioners and force-limiting devices can be provided on the first belt retractor 13, on the end fitting 14, or even on the belt buckle 11.

The occupant 1 is restrained by a restraint system designed according to the invention having a seat belt device 2 and an airbag 15 according to the invention arranged on the diagonal belt portion 6, wherein the airbag 15 is visible due to a thickening of the seat belt 18 in the region of the diagonal belt portion 6. Furthermore, a second belt retractor can be provided, which is provided instead of the end fitting 14 and rolls up the seat belt 18 from the free end of the lap belt portion 7. The lap belt portion 7 and the diagonal belt portion 6 can then preferably be designed as separate belt portions, in that they are fixedly connected to the belt tongue 12 by one end in each case. In this case, the belt tongue 12 is guided non-displaceably on the seat belt 18 and forms a separation between the lap belt portion 7 and the diagonal belt portion 6. The airbag 15 is held and arranged on the diagonal belt portion 6, via a holder, in such a position that the diagonal belt portion 6 can be completely wound up into the parked position via the first belt retractor 13, without the airbag 15 having to be wound up using the first belt retractor 13. The holder can be part of the airbag 15, e.g., in the form of loops provided on the airbag 15, or can also be a holder separate from the airbag 15, wherein the holder can additionally also form a cover of the airbag 15. The airbag 15 is assigned a gas generator (not shown) which, when activated, promptly generates a large amount of gas and thereby inflates the airbag 15 to the geometry shown in FIGS. 2 to 4. The gas generator can be arranged on and/or fastened to the belt retractor 13 or belt buckle 12, or can also be fastened to the vehicle structure externally in a separate fastening, provided that it is connected, in terms of flow, to the airbag 15.

In the inflated state, the airbag 15 has a triangular basic shape, as can be seen in the left-hand illustration of FIG. 4, with three rounded corners 20, 21, and 22 and is fastened to the diagonal belt portion 6 via a holder (not shown). For fastening the airbag 15 to the diagonal belt portion 6, a housing or a casing can be provided which encloses the airbag 15 in the folded or rolled state and is fastened to the diagonal belt portion 6. Alternatively, mounting of the airbag 15 can also be realized by directly sewing the airbag 15 to the diagonal belt portion 6, wherein a casing or a housing for encapsulating the airbag 15 can additionally be provided.

The orientation of the airbag 15 relative to the diagonal belt portion 6, which can be seen in FIG. 4, is defined by the mounting of the airbag 15 on the diagonal belt portion 6. The airbag 15 has an orientation in which two of the rounded corners 21 and 22 are arranged horizontally next to each other. The third rounded corner 20 extends centrally upwards between the horizontally arranged rounded corners 21 and 22, such that a triangular basic shape of the airbag 15 results. Due to its mounting on the diagonal belt portion 6, the airbag 15 is oriented such that the two rounded corners 21 and 22 arranged horizontally next to each other are arranged on different sides of the diagonal belt portion 6, and the central, upper rounded corner 20 is arranged above the diagonal belt portion 6.

The lower rounded corners 21 and 22 arranged horizontally next to each other have a smaller radius RA than the central, upper rounded corner 20. The airbag 15 thus has a larger surface area in the region of the upper rounded corner 20 than in the regions of the lower rounded corners 21 and 22 that are arranged next to each other. The edge faces 23, 24, and 25 of the airbag 15 have a curvature directed radially inwards with respect to the airbag 15, whereby the volume of the airbag 15 is reduced while maintaining the dimensions in the rounded corners 20, 21, and 22. The lower edge face 25, which connects the corners 21 and 22 arranged horizontally next to each other, has a smaller radius of curvature R1, while the edge faces 23 and 24, which connect the lateral corners 21 and 22 to the central corner 20, have a larger radius of curvature R2 by comparison. The lower edge face 25 thus extends deeper into the airbag 15 than the lateral edge faces 23 and 24. As can be seen in the middle illustration of FIG. 4, a tensioning strap 17 can additionally be attached to the diagonal belt portion 6 and is connected with its free end to the airbag 15, and holds the airbag 15 in position during inflation and limits the deflection of the airbag 15 during inflation. In addition, in the diagonal belt portion 6, a gas line 19 can be provided, as can be seen in the right-hand illustration of FIG. 4, which is connected, in terms of flow, to both the gas generator and the airbag 15. For this purpose, the tensioning strap 17 can also be designed as a gas line.

As can be seen in FIG. 2, due to the described fastening to the diagonal belt portion 6 and the orientation defined thereby, the airbag 15 is inflated such that the occupant 1 is covered by the airbag 15 in the area of his head 8 by the portion of the upper, central rounded corner 20 of the airbag 15 and in the area of his shoulders 26 by the portions of the rounded corners 21 and 22 of the airbag 15 that are arranged next to each other. In the normal driving position of the occupant 1, the airbag 15 is supported below the portions of the corners 21 and 22 arranged next to each other, i.e., on the edge face 25 by the upper arms of the occupant 1. Thus, when the occupant 1 is displaced forwards in an accident, his head 8 plunges into the upper portion of the airbag 15, formed by the central, upper rounded corner 20, and his shoulders 26 plunge into the lower portions, arranged horizontally next to each other, of the rounded corners 21 and 22 of the airbag 15. Due to its shape, the airbag 15 practically forms a copy of the geometry of the occupant 1 in the area of the head and shoulders. Since the head 8 and the shoulders 26 travel the greatest distance when displaced forwards from the normal driving position in case of an accident and are subject to particularly great acceleration, restraint of the occupant 1 in the area of these body parts provides particularly effective protection and a particularly effective reduction of the load on the occupant in case of an accident.

FIG. 3 shows the restraint system of FIG. 2 with a steering wheel 8 and a driver airbag 16 inflated from the steering wheel 8. The airbag 15 held on the diagonal belt portion 6 is positioned and oriented in its inflated state such that it is located between the driver airbag 16 and the occupant 1, covering the chest 5 in the area of the shoulders 26 and the front of the head 8.

1. A restraint system of a motor vehicle for restraining an occupant sitting on a vehicle seat, having a seat belt device with
an inflatable airbag, and
a gas generator which is connected, in terms of flow, to the airbag and, upon activation, inflates the airbag with a gas, wherein
the airbag has a holder for holding the airbag on a diagonal belt portion of a seat belt of the seat belt device, which diagonal belt portion crosses the chest of the occupant, wherein
the airbag has a triangular basic shape with rounded corners, and
the airbag, when inflated, has an orientation defined by its mounting on the diagonal belt portion with two rounded corners arranged horizontally next to each other and with a rounded corner extending centrally upwards between the horizontally arranged corners.

2. The restraint system according to claim 1, wherein
the corners of the airbag (when inflated, which corners are arranged horizontally next to each other, are arranged on different sides of the diagonal belt portion

3. The restraint system according to claim 1, wherein
the centrally upwards-extending rounded corner of the airbag, when inflated, is arranged above the diagonal belt portion.

4. The restraint system according to claim 1, wherein
the rounded corners arranged horizontally next to each other have a smaller radius (RA) than the centrally raised rounded corner.

5. The restraint system according to claim 1, wherein
the airbag has a radially inwardly curved shape on its edge faces which connect the rounded corners to each other.

6. The restraint system according to claim 5, wherein
the airbag has a smaller radius of curvature on the lower edge face, which connects the two rounded corners arranged horizontally next to each other, than on the lateral edge faces, which connect the rounded corners arranged horizontally next to each other to the upper, central rounded corner.

7. The restraint system according to claim 1, wherein
the airbag is symmetrical with respect to a vertically oriented axis of symmetry which extends centrally through the upwards-extending rounded corner of the airbag.

8. The restraint system according to claim 1, wherein
the diagonal belt portion has a gas line which connects the gas generator, in terms of flow, to the airbag.

9. The restraint system according to claim 1, wherein
a tensioning strap is provided, which, when inflated, connects the airbag to the diagonal belt portion and limits a deflection of the airbag when inflated.

10. An inflatable airbag for mounting on a diagonal belt portion of a seat belt device, wherein
the airbag has a triangular basic shape with rounded corners, and
the airbag, when inflated, has an orientation defined by its mounting on the diagonal belt portion, with two rounded corners arranged horizontally next to each other and with a rounded corner extending centrally upwards between the horizontally arranged corners.

11. The inflatable airbag according to claim 10, wherein
the rounded corners of the airbag when inflated, which corners are arranged horizontally next to each other, are arranged on different sides of the diagonal belt portion.

12. The inflatable airbag according to claim 10, wherein
the centrally upwards-extending rounded corner of the airbag, when inflated, is arranged above the diagonal belt portion.

13. The Inflatable airbag according to claim 10, wherein
the rounded corners arranged horizontally next to each other have a smaller radius than the centrally raised rounded corner.

14. The inflatable airbag according to claim 10, wherein
the airbag has a radially inwardly curved shape on its edge faces which connect the rounded corners to each other.

15. The inflatable airbag according to claim 14, wherein
the airbag has a smaller radius of curvature on the lower edge face, which connects the two rounded corners arranged horizontally next to each other, than on the lateral edge faces, which connect the rounded corners arranged horizontally next to each other to the upper, central rounded corner.

16. The inflatable airbag according to claim 10, wherein
the airbag is symmetrical with respect to an axis of symmetry which extends centrally through the upwards-extending rounded corner.
